(19) United States
(12) Patent Application Publication
(10) Pub. No.: US 2013/0145878 A1
(43) Pub. Date: Jun. 13, 2013

(54) SCISSORS GEAR STRUCTURE AND MANUFACTURING METHOD THEREOF

(71) Applicants: Shin Gyu Kim, Hwaseong (KR); Ki Bum Kim, Hwaseong (KR); Jae Kyu Lee, Hwaseong, (KR); Tae Hoon Roh, Seoul (KR); Ki Jung Kim, Hwaseong (KR)

(72) Inventors: Shin Gyu Kim, Hwaseong (KR); Ki Bum Kim, Hwaseong (KR); Jae Kyu Lee, Hwaseong, (KR); Tae Hoon Roh, Seoul (KR); Ki Jung Kim, Hwaseong (KR)

(73) Assignees: KIA MOTORS CORPORATION, Seoul (KR); HYUNDAI MOTOR COMPANY, Seoul (KR)

(21) Appl. No.: 13/529,205

(22) Filed: Jun. 21, 2012

(30) Foreign Application Priority Data
Dec. 8, 2011 (KR) 10-2011-0130846

(51) Int. Cl. F16H 55/17; B22F 5/08; B22F 3/24; F16H 55/06

(52) U.S. Cl. 74/445; 419/14

(57) ABSTRACT

Disclosed is a scissors gear structure and a method of manufacturing the same, wherein the scissors gear can efficiently remove backlash and prevent noise and vibrations, and wherein the scissors gear has improved mechanical properties including strength and wear resistance. The present invention provides a scissors gear without requiring separate manufacturing of expensive scissors pins which must be forcibly inserted, and without requiring expensive processing such as fine wire cutting to form grooves at both ends of the scissors spring.

### CROSS-REFERENCE TO RELATED APPLICATIONS

The present application claims priority to Korean Patent Application No. 10-2011-0130846 filed on Dec. 8, 2011, the entire contents of which is incorporated herein for purposes by this reference.

### BACKGROUND OF THE INVENTION

1. Field of the Invention

The present invention relates to a scissors gear structure and a method of manufacturing the same, and more particularly to scissors gear having improved strength and wear resistance and a technique which reduces manufacturing costs.

2. Background Art

A scissors gear is a device for preventing the generation of vibrations and noise due to backlash between gears in the connection of gears such as, for example, cam gears of an engine that are engaged with each other to transfer power.

FIG. 1 shows a conventional scissors gear structure, which is configured such that a main gear 500 and a sub gear 502 are elastically rotatable relative to each other by means of a scissors spring 504. In order to enable the main gear 500 and the sub gear 502 to be elastically rotatable relative to each other, the main gear 500 and the sub gear 502 are respectively provided with scissors pins 506 that support the ends of the scissors spring 504, and the scissors spring 504 includes grooves 508 at both ends thereof so as to increase the contact area with the scissors pins 506 and to achieve precise engagement.

The scissors pins 506 mounted to the main gear 500 and the sub gear 502 are formed of chromium plating pins which are an expensive bearing steel material and, thus, are typically manufactured separately and forcibly inserted in the main gear 500 and the sub gear 502. Furthermore, the grooves 508 of the scissors spring 504 are formed using fine wire cutting, thus resulting in high manufacturing costs, and undesirably increasing the price of the scissors gear.

The above information disclosed in this Background Art section is merely utilized to enhance understanding about the background of the present invention, and should not be regarded as conventional techniques known to those having ordinary knowledge in the art.

### SUMMARY OF THE INVENTION

Accordingly, the present invention has been made keeping in mind the above problems encountered in the related art, and an object of the present invention is to provide a scissors gear structure, which may perform as well as or better than conventional scissors gear structures in removing backlash and preventing noise and vibrations without requiring the manufacture of expensive scissors pins which are forcibly inserted, and without requiring expensive processing steps such as fine wire cutting to form grooves at both ends of the scissors spring. A further object of the present invention is to provide a scissors gear having improved mechanical properties including strength and wear resistance, and a method of manufacturing such a scissors gear.

According to one aspect, the present invention provides a scissors gear structure, comprising a main gear and a sub gear concentrically disposed so as to be rotatable relative to each other; an arc-shaped scissors spring that provides an elastic force so that the main gear and the sub gear are rotatable relative to each other; and a support projection integrally formed to project at a position where the main gear and the sub gear face each other so as to support both ends of the scissors spring.

According to a further aspect, the present invention provides a method of manufacturing a scissors gear, comprising molding powder comprising a combination of carbon (C), molybdenum (Mo) and iron (Fe), particularly about 0.15˜0.25 Wt % of carbon (C), about 0.5˜1.5 wt % of molybdenum (Mo), a remainder of iron (Fe) and the others less than 1 wt % thus forming molded bodies of each of a main gear and a sub gear; sintering the molded bodies thus forming sintered bodies; rolling the sintered bodies thus forming rolled bodies wherein a jagged surface thereof is compacted; and thermally treating the rolled bodies using carburization to increase hardness of the jagged surface thus forming the main gear and the sub gear.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional scissors gear;

FIG. 2 is a view showing a main gear and a sub gear of a scissors gear according to an embodiment of the present invention;

FIG. 3 is a view showing a scissors spring and a support projection of the scissors gear of FIG. 2 according to a first embodiment;

FIG. 4 is a view showing a scissors spring and a support projection according to a second embodiment;

FIG. 5 is a view showing a scissors spring and a support projection according to a third embodiment;

FIG. 6 is a view showing a scissors spring and a support projection according to a fourth embodiment; and

FIG. 7 is a flowchart showing a process of manufacturing the scissors gear according to an embodiment of the present invention.

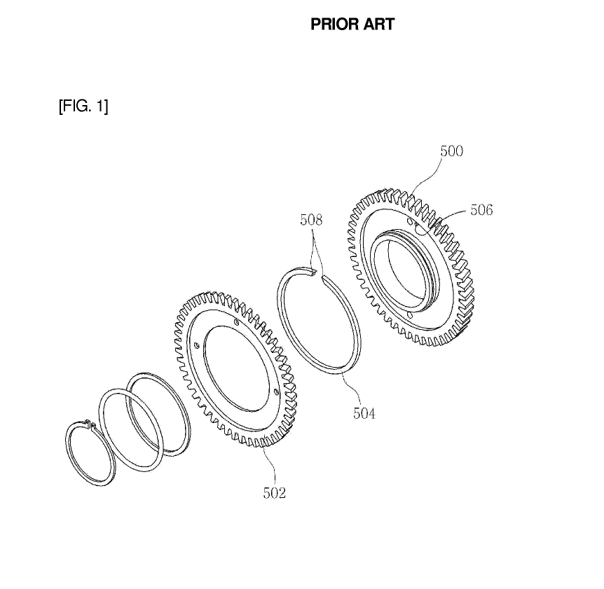

### DESCRIPTION OF SPECIFIC EMBODIMENTS

According to embodiments of the present invention, the scissors gear structure comprises a main gear 1 and a sub gear 3 which are concentrically disposed so as to be rotatable relative to each other; a scissors spring 5 that provides an elastic force so as to enable the main gear 1 and the sub gear 3 to be rotatable relative to each other, wherein the scissors spring 5 is preferably arc-shaped; and support projections 7 integrally formed to project at positions where the main gear 1 and the sub gear 3 face each other so that both ends of the scissors spring 5 are respectively supported.

Unlike the conventional scissor gear structure, the present invention does not separately manufacture expensive scissors pins which are forcibly inserted into the main gear 1 and the sub gear 3. Rather, according to the present invention the support projections 7, which perform the functions of the conventional scissors pins, are integrally formed upon manufacturing the main gear 1 and the sub gear 3. Further, and the scissors spring 5 has a simple end structure and may, thus, be easily formed using cutting or blanking. As a result, the present invention reduces the cost of manufacturing the scissors gear.

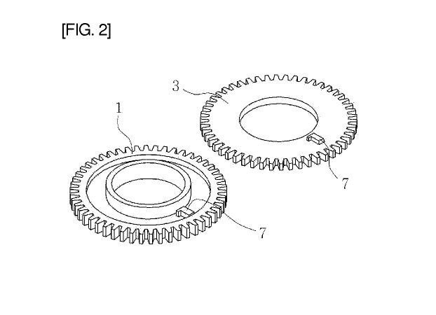

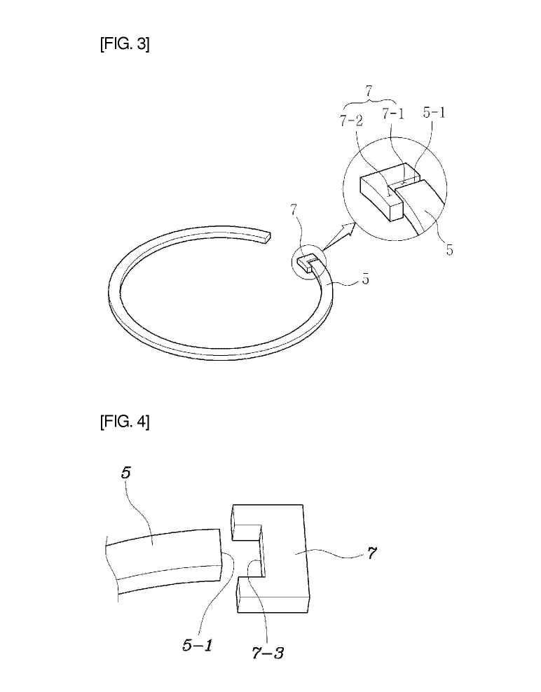

FIG. 3 shows the scissors spring 5 and the support projection 7 according to a first embodiment. As shown, the end of the scissors spring 5 comprises a planar end 5-1 having a shape linearly cut in a radial direction of the main gear 1 and the sub gear 3. The support projection 7 includes a support planar part 7-1 that provides a plane that comes into surface contact with the planar end 5-1, and a radial control part 7-2 that limits the movement of the end of the scissors spring 5. In particular, according to various embodiments, the radial control part 7-2 limits the movement of the end of the scissors spring 5 inward in the radial direction of the main gear 1 and the sub gear 3. This general structure of the support projection 7 is also illustrated in FIG. 2.

Because the planar end 5-1 is simply formed by linearly cutting the end of the scissors spring 5, the manufacturing of the scissors spring 5 may be easy and inexpensive. Further, the support projections 7 of the main gear 1 and the sub gear 3, which respectively support the ends of the scissors spring 5, may be integrally formed by being sintered from a powder upon manufacturing the main gear 1 and the sub gear 3. As such, the strength and wear resistance of the scissors gear is improved without generating additional costs.

According to embodiments of the present invention, the support planar part 7-1 of the support projection 7 comes into surface contact with the planar end 5-1 of the scissors spring 5 thus achieving more stable contact and support over a larger area as compared to conventional cases. This provides stress distribution effects in proportion to an increase in the contact support area, so that the strength and wear resistance are ensured and the durability is enhanced. Further, the radial control part 7-2 prevents the end of the scissors spring 5 from moving inward in the radial direction, thus maintaining a stable support condition.

FIG. 4 shows the scissors spring 5 and the support projection 7 according to a second embodiment, wherein the end of the scissors spring 5 comprises a planar end 5-1 having a shape linearly cut in the radial direction of the main gear 1 and the sub gear 3 as in the above embodiment. As further shown, the support projection 7 includes a rectangular recess 7-3 into which the planar end 5-1 is inserted so as to maintain the surface contact condition.

In addition to the support planar part 7-1 and the radial control part 7-2 being orthogonal to each other to form the shape ‘L’ in the first embodiment, in the second embodiment the rectangular recess 7-3 is provided in the support projection 7 so that the planar end 5-1 of the scissors spring is completely inserted therein to enable three-surface support.

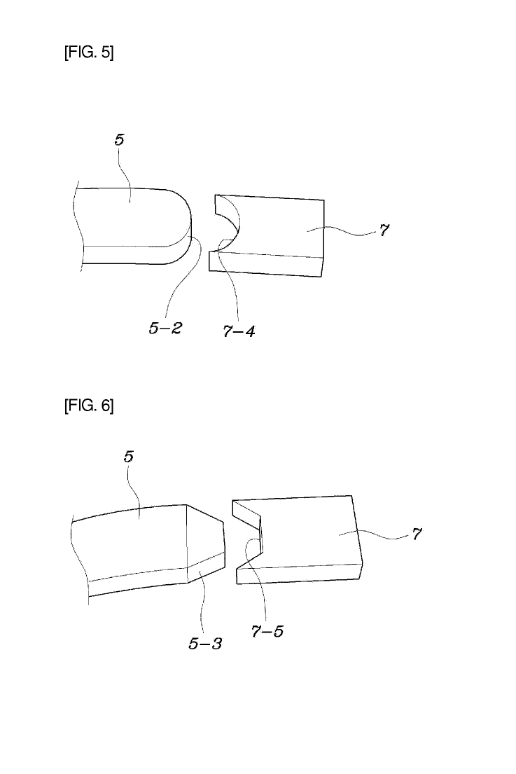

FIG. 5 shows the scissors spring 5 and the support projection 7 according to a third embodiment, wherein the end of the scissors spring 5 comprises an arc-shaped end 5-2 in the form of an arc. As shown in this embodiment, the central portion of the arc is convex. As further shown, the support projection 7 includes an arc-shaped recess 7-4 complementary to the arc-shaped end 5-2 so as to form the surface contact condition.

Accordingly, the support projection 7 supports the scissors spring 5 not only in the circumferential direction of the scissors spring 5 that originally provides an elastic force but also in the radial direction thereof. Further, the entire arc-shaped end 5-2 of the scissors spring 5 is supported by the entire arc-shaped recess 7-4, thus increasing the contact support area to thereby obtain enhanced stress distribution effects.

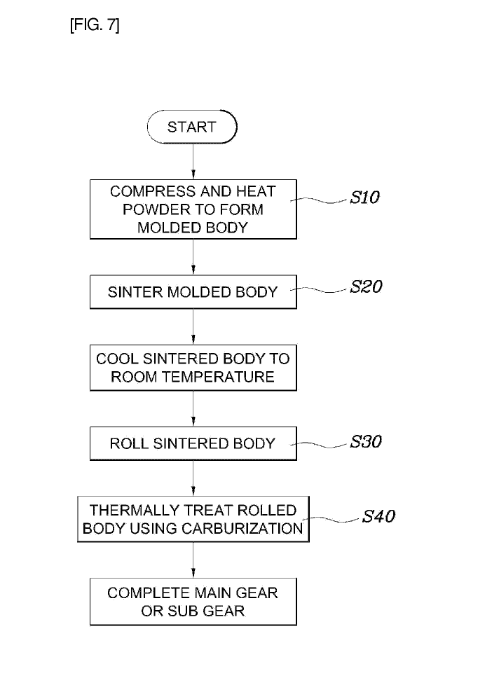

FIG. 6 shows the scissors spring 5 and the support projection 7 according to a fourth embodiment, wherein the end of the scissors spring 5 comprises a trapezoidal end 5-3 formed into a trapezoidal shape which narrows toward the tip thereof. As shown, and the support projection 7 includes a trapezoidal recess 7-5 complementary to the trapezoidal end 5-3 so as to form the surface contact condition. As in the above embodiments, this structure stably supports the end of the scissors spring 5. This structure may further exhibit enhanced stress distribution effects in proportion to an increase in the contact support area for the load that acts on the scissors spring 5, thereby enhancing the total durability of the scissors gear.

According to various embodiments, the main gear 1 and the sub gear 3 are integrally formed with such support projections 7. In particular, the main gear 1 and the sub gear 3 with the integral support projections are formed by subjecting powder comprising a blend of carbon (C), molybdenum (Mo), iron (Fe) and other optional components to molding, sintering, rolling, and thermal treatment. According to an exemplary embodiment, the powder comprises about 0.15˜0.25 wt % of carbon (C), about 0.5˜1.5 wt % of molybdenum (Mo), the remainder of iron (Fe), and optionally one or more other components provided in an amount of less than 1 wt %, and it is subjected to molding, sintering, rolling, and thermal treatment using carburization.

It has been found that if the amount of C is less than 0.15 wt %, then the hardenability and hardness upon thermal treatment may be decreased. In contrast, if the amount thereof exceeds 0.3 wt %, impact resistance may decrease which is attributable to brittleness after thermal treatment. If the amount of Mo is less than 0.5 wt %, mechanical properties and hardenability of the material may decrease. In contrast, if the amount thereof exceeds 1.5 wt %, the material cost may become excessive and moldability may decrease.

More specifically, according to an exemplary embodiment the method of manufacturing the scissors gear according to the present invention comprises, as shown in FIG. 7, molding powder comprising about 0.15˜0.25 wt % of C, about 0.5˜1.5 wt % of Mo, the remainder of Fe, with any other materials contained at less than about 1 wt %, thus forming molded bodies of each of the main gear 1 and the sub gear 3 (S10); sintering the molded bodies, thus forming sintered bodies (S20); rolling the sintered bodies, thus forming rolled bodies wherein a jagged surface thereof is compacted (S30); thermally treating the rolled bodies using carburization to increase the hardness of the jagged surface, thus forming the main gear 1 and the sub gear 3 (S40).

According to various embodiments, in the molding step (S10), an upper mold and a lower mold are filled with the powder at about 100° C. or higher and the powder is compressed by the mold to form the molded bodies. The molding is carried out so as to provide a desired density of the molded bodies, such as about 7.3 g/cc or more and also so that the support projections 7 are integrally formed.

Upon sintering (S20), the molded bodies are sintered in a reduction atmosphere at a suitable sintering temperature, such as about 1100˜1300° C., for a suitable time, such as about 30 min to 2 hr.

If the sintering temperature is too low, such as less than 1100° C., it is not efficient to diffuse powder materials and to form necking between powder particles. On the other hand if the sintering temperature is to high, such as higher than 1300° C., mass production may undesirably remarkably decrease.

The rolling step (S30) is carried out by cooling the sintered bodies, such as to room temperature, after sintering (S20), and the inside of the sintered bodies are fixed and a rolling die is positioned at the outside thereof to perform rotation and compression. This is carried out so as to obtain the desired depth of the jagged surface which is compacted is, such as a depth of about 150˜400 μm.

If the depth of the jagged surface which is compacted is too low, such as less than 150 μm, desired mechanical properties may not be satisfied. In contrast, if the depth of the jagged surface which is compacted is too high, such as exceeding 400 μm, residual stress may become excessive due to rolling and undesirably increasing thermal deformation upon thermal treatment (S40).

As described hereinbefore, the present invention provides a scissors gear structure and a method of manufacturing the same. According to the present invention, the scissors gear can efficiently exhibit the functions of removing backlash and preventing noise and vibrations even without the need to separately manufacture expensive scissors pins which are conventionally formed and forcibly inserted in the main gear and sub gear. The scissors gear can also be provided without the need to perform expensive processing, such as fine wire cutting to form grooves at both ends of the scissors spring. Further, according to the present invention mechanical properties including strength and wear resistance can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A scissors gear structure, comprising:
a main gear and a sub gear concentrically disposed so as to be rotatable relative to each other;
an scissors spring disposed between the main gear and sub gear that provides an elastic force so that the main gear and the sub gear are rotatable relative to each other; and
a support projection integrally formed on the main gear and the sub gear, the support projection disposed at positions on the main gear and sub gear so as to support the scissors spring.

2. The scissors gear structure of claim 1, wherein the scissors spring is arc-shaped and has two ends.

3. The scissors gear structure of claim 1, wherein each of the two ends of the arc-shaped scissors spring is supported by the support projections on the main gear and the sub gear.

4. The scissors gear structure of claim 1, wherein an end of the scissors spring comprises a planar end having a shape linearly cut in a radial direction of the main gear and the sub gear, and wherein the support projection includes
a support planar part that provides a planar surface in surface contact with the planar end of the scissors spring, and
a radial control part positioned to limit movement of the end of the scissors spring inward in the radial direction of the main gear and the sub gear.

5. The scissors gear structure of claim 1, wherein an end of the scissors spring comprises a planar end linearly extending in a radial direction of the main gear and the sub gear, and wherein the support projection includes a rectangular recess into which the planar end is inserted so as to form a surface contact condition.

6. The scissors gear structure of claim 1, wherein an end of the scissors spring comprises a convex arc-shaped end, and the support projection includes an arc-shaped recess complementary to the arc-shaped end so as to form a surface contact condition.

7. The scissors gear structure of claim 1, wherein an end of the scissors spring comprises a trapezoidal end which narrows toward a tip thereof, and the support projection includes a trapezoidal recess complementary to the trapezoidal end so as to form a surface contact condition.

8. The scissors gear structure of claim 1, wherein the main gear and the sub gear are formed by subjecting powder comprising about 0.15˜0.25 wt % of carbon (C), about 0.5˜1.5 wt % of molybdenum (Mo), a remainder of iron (Fe), and other optional materials present at less than 1 wt %, to molding, sintering, rolling, and thermal treatment using carburization.

9. A method of manufacturing a scissors gear, comprising:
molding powder comprising about 0.15˜0.25 wt % of carbon (C), about 0.5˜1.5 wt % of molybdenum (Mo), a remainder of iron (Fe), and other optional materials at less than 1 wt %, thus forming molded bodies of each of a main gear and a sub gear (S10);
sintering the molded bodies, thus forming sintered bodies (S20);
rolling the sintered bodies, thus forming rolled bodies wherein a jagged surface thereof is compacted (S30); and
thermally treating the rolled bodies using carburization to increase hardness of the jagged surface, thus forming the main gear and the sub gear (S40).

10. The method of claim 9, wherein the molding (S10) is performed by adding the powder to an upper mold and a lower mold at about 100° C. or higher and compressing the upper mold and lower mold to provide a molded body having a density of about 7.3 g/cc or more.

11. The method of claim 9, wherein the sintering (S20) is performed in a reduced atmosphere at about 1100˜1300° C. for about 30 min to 2 hr.

12. The method of claim 9, wherein the rolling (S30) is performed by cooling the sintered body to about room temperature after sintering (S20), and the rolling (S30) is performed so that a depth of the compacted jagged surface is about 150˜400 μm.
